(19) United States
(12) Patent Application Publication
(10) Pub. No.: US 2008/0057262 A1
(43) Pub. Date: Mar. 6, 2008

(54) Low-Reflection Material

(75) Inventors: Kazuya Ooishi, Shizuoka (JP); Kensaku Higashi, Shizuoka (JP)

Correspondence Address: OLIFF & BERRIDGE, PLC, P.O. BOX 320850, ALEXANDRIA, VA, 22320-4850, US

(73) Assignee: TOMOEGAWA CO., LTD., Tokyo (JP)

(21) Appl. No.: 10/594,769

(22) PCT Filed: Mar. 24, 2005
(86) PCT No.: PCT/JP05/05359

§ 371 Date: Sep. 29, 2006

(30) Foreign Application Priority Data
Mar. 30, 2004 (JP) 2004-100552

(51) Int. Cl. B32B 7/00

(52) U.S. Cl. 428/98

(57) ABSTRACT

A low-reflection material having a fluorine-containing polymer film which can improve abrasion resistance without increasing production cost is provided. In the low-reflection material comprising a transparent substrate, a hard coating layer provided on the transparent substrate, and a fluorine-containing polymer film provided on the hard coating layer, the hard coating layer contains ethylene oxide modified (meth)acrylate resin. Additionally, in the low-reflection material comprising a transparent substrate, a hard coating layer provided on the transparent substrate, a high refractive index layer provided on the hard coating layer, and a fluorine-containing polymer film provided on the high refractive index layer, the high refractive index layer contains ethylene oxide modified (meth)acrylate resin.

### TECHNICAL FIELD

The present invention relates to an anti-reflection material which is formed on the surface of a display such as an LCD, PDP, etc., and in particular, relates to a low-reflection material which can be provided by coating at low cost.

### BACKGROUND ART

In recent years, displays such as LCDs, PDPs, etc., have made progress, and products of various sizes which are used for a variety of purposes such as portable telephones, TVs, etc., have been produced and sold. In general, a layer having an anti-reflection function is provided on the surface of these displays in order to further improve visibility. The anti-reflection technology includes an anti-glare film to prevent ambient light from being reflected and an anti-reflection coating for reducing the reflectivity thereof.

As conventional anti-glare techniques, a method in which an anti-glare film is produced by coating a coating material containing fillers thereon, so as to roughen the surface thereof, etc., can be primarily used, and additionally, as a conventional anti-reflection technique, a method in which an anti-reflection film is formed by sputtering, etc., can be primarily used. However, a vacuum film forming method such as the latter sputtering is expensive, and it is difficult to form a film in which large areas are uniform, and therefore, recently a method in which an anti-reflection film is formed by a wet coating, is used. Reflectivity of an anti-reflection film produced by the sputtering is usually 0.3% or less; however, reflectivity of a film produced by the wet coating is higher than that by the wet coating, and it typically may be about 1.0%, and this is called “low-reflection” to distinguish it from the “anti-reflection”.

In recent years, displays used in large screen TVs are in great demand, and as a result, low-reflection films produced by the wet coating are also in great demand. As a low-reflection film, a two-layer type structure in which a hard coating layer and a low refractive index layer are provided on a transparent film made of polyethylene terephthalate (PET), triacetylcellulose (TAC), etc., and a three-layer type structure in which a hard coating layer, a high refractive index layer, and a low refractive index layer are provided on the transparent film, are produced and have been sold. As a material to form this low refractive index layer, two types of material in which a silicate film is formed using a sol-gel reaction and material in which a fluorine-containing polymer film is formed, are primarily used. In connection with the former material, a hard film having a hardness similar to that of silica is formed by coating a coating material consisting primarily of alkoxysilane and hydrolyzate thereof and by heating so as to carry out a dehydration condensation reaction, and in addition, in order to decrease the refractive index, alkoxysilane having a fluorine-containing alkyl group is included as a part of the raw material, or holes are formed in the film (for example, see Patent Publication 1). In addition, in connection with the fluorine-containing polymer film, a fluorine-containing polymer film is formed by coating polymerizable fluorine-containing monomers or oligomers and by polymerizing using irradiation with an electron beam or ultraviolet light (for example, see Patent Publication 2).

Since these low refractive index materials are provided on the outermost surface of the low-reflection film, high chemical resistance and abrasion resistance are also desired in addition to high optical properties such as low refractive index, and moreover, high productivity in mass-production is also desired as an important feature.

Patent Publication 1 is Japanese Unexamined Patent Application Publication No. Hei 09-208898 (Abstract). Patent Publication 2 is Japanese Unexamined Patent Application Publication No. Hei 10-182558 (Abstract).

### DISCLOSURE OF THE INVENTION

### Problems Solved by the Invention

However, the above-mentioned silicate film originally has high hardness and superior abrasion resistance, but it is necessary to carry out dehydration condensation reaction in the coated film, and as a result, heat curing at a high temperature of 100° C. or more for a substantial number of minutes, or at a high temperature of 60° C. or more for a few days to several weeks, is required. Therefore, there are problems in productivity in that the yield is reduced due to deformation of the produced film, a special heating chamber for curing is required, it takes long term to cure, and the like. In addition, with respect to the fluorine-containing polymer film, there is an advantage in production in that a polymer film can be formed in a short time since it is polymerized by irradiation of electron beams or ultraviolet light; however, there is a defect in that the formed polymer film has insufficient abrasion resistance in comparison with that of a silicate film.

The present invention was made in view of the above circumstances, and objects of the present invention are therefore to provide a low-reflection material having a fluorine-containing polymer film in which productivity is high and abrasion resistance is improved.

### Means for Solving the Problems

The present inventors conducted research in order to solve the above problems, and as a result, they found that the abrasion resistance could be remarkably improved by adding specific materials in a ground layer of fluorine-containing polymer film, thereby accomplishing the present invention. That is, the low-reflection material according to the first aspect of the present invention comprises a hard coating layer provided on a transparent substrate, and a fluorine-containing polymer layer provided on the hard coating layer, wherein the hard coating layer includes ethylene oxide modified (meth)acrylate resin.

According to the present invention, since ethylene oxide modified (meth)acrylate resin is included in the hard coating layer, the adhesive strength of the fluorine-containing polymer film is improved and superior abrasion resistance is exhibited.

In addition, the low-reflection material according to the second aspect of the present invention comprises a hard coating layer provided on a transparent substrate, a high refractive index layer provided on the hard coating layer, and a fluorine-containing polymer film provided on the high refractive index layer, wherein the high refractive index layer includes ethylene oxide modified (meth)acrylate resin.

Also in the second aspect, in the same manner as described above, since ethylene oxide modified (meth)acrylate resin is included in the high refractive index layer, superior anti-reflectivity is exhibited, and in addition, the adhesive strength of the fluorine-containing polymer film is improved and superior abrasion resistance is exhibited.

### BEST MODE FOR CARRYING OUT THE INVENTION

In the following, preferable embodiments of the present invention will be explained.

### A. Transparent Substrate

As a transparent substrate employed in a low-reflection material according to the present invention, a conventional transparent film, glass, etc., can be employed. Specifically, various resin films such as polyethylene terephthalate (PET), polyethylene naphthalate (PEN), triacetyl cellulose (TAC), polyacrylate, polyimide, polyether, polycarbonate, polysulfone, polyether sulfone, cellophane, aromatic polyamide, polyethylene, polypropylene, polyvinyl alcohol, and the like, and glass-based materials such as fused glass, soda glass, and the like can be preferably employed. For PDPs and LCDs, PET and TAC are preferred.

The higher the transparency of the transparent substrate, the better the transparent substrate. The light transmittance (Japanese Industrial Standard JIS K7361-1) is preferably 80% or more, and is more preferably 90% or more. In the case in which the transparent substrate is employed in a compact and lightweight liquid-crystal display, the transparent substrate is preferably in the form of a film. It is desirable that the transparent substrate be thin from the standpoint of being light in weight, and it is preferred that the thickness of the transparent substrate be 1 to 700 μm, and more preferably 25 to 250 μm in consideration of the productivity thereof.

In addition, the adhesion between the transparent substrate and the hard coating layer, or another layer, can be improved by surface-treatment of the transparent substrate such as an alkaline treatment, corona treatment, plasma treatment, fluorine treatment, sputtering treatment, or the like, a coating, on the transparent substrate, of a surface active agent, a silane coupling agent, or the like, or a surface-modification-treatment such as a Si deposition or the like.

### B. Hard Coating Layer

In the present invention, “hard coating” refers to having a hardness of H or more according to the pencil hardness test (Japanese Industrial Standard JIS K-5400). In addition, in the present invention, “high refractive index and low refractive index” refer to relative relationships between refractive indexes of adjoining layers.

As a resin for forming the hard coating layer in the first aspect of the low-reflection material of the present invention, a resin which is cured by means of radiation or heat, or a combination thereof, can be used; however, it is necessary to contain ethylene oxide modified (meth)acrylate resin. In the hard coating layer in the second aspect (transparent substrate, hard coating layer, high refractive index layer, and fluorine-containing polymer film, in order from bottom to top) of the present invention, common radiation curable resins and thermosetting resins as described below can be used, and ethylene oxide modified (meth)acrylate resin may not be included.

As the above ethylene oxide modified (meth)acrylate resin, monomers as described below can be used alone or in combination as copolymer thereof or copolymer with other vinyl type monomers. As an example of such monomers, esterified compounds of (meth)acrylate and alkylene oxide adduct of alkyl alcohol such as ethanol, methanol, n-propyl alcohol, isopropyl alcohol, n-butyl alcohol, isobutyl alcohol, n-heptyl alcohol, n-octyl alcohol, 2-ethylhexyl alcohol, isooctyl alcohol, n-nonyl alcohol, isononyl alcohol, etc., and esterified compounds of (meth)acrylate and ethylene oxide adduct of aromatic alcohol such as phenol, etc., or aromatic alcohol having long chain alkyl group such as nonyl phenol, etc., can be used. These compounds are shown by the following Chemical Formula 1.

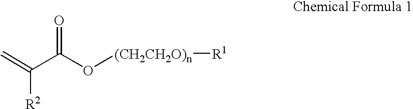

(In the chemical formula, n is an integer of 1 to 9, R¹ is a methyl group, ethyl group, propyl group, butyl group, hexyl group, heptyl group, octyl group, nonyl group, phenyl group, or phenyl group with an alkyl group having a carbon number of 1 to 9, and R² is H or a methyl group.)

In addition, esterified compounds of (meth)acrylate and ethylene glycol, diethylene glycol or triethyleneglycol shown in Chemical Formula 2, esterified compounds of (meth)acrylate and ethylene oxide adduct of bisphenol such as bisphenol A, bisphenol F, etc., shown in Chemical Formulas 3 and 4, can be used.

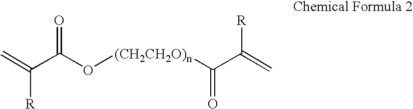

(In the chemical formula, n is an integer of 1 to 9, and R is H or a methyl group.)

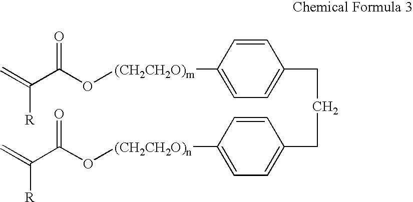

(In the chemical formula, the total of m and n is an integer of 2 to 10, and R is H or a methyl group.)

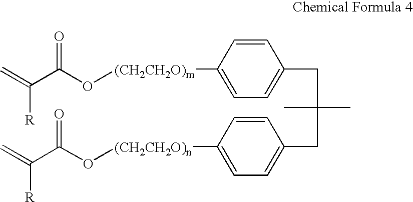

(In the chemical formula, the total of m and n is an integer of 2 to 10, and R is H or a methyl group.)

Furthermore, esterified compounds of acrylate and ethylene oxide adduct of a polyol such as trimethylol propane, di-trimethylol propane, pentaerythritol, di-pentaerythritol, etc., shown in Chemical Formulas 5 to 7, can be preferably used.

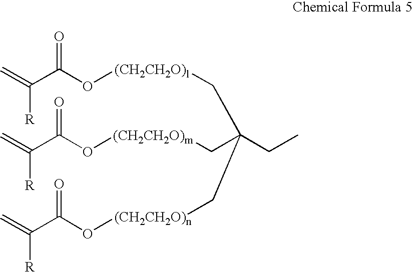

(In the chemical formula, the total of 1, m, and n is an integer of 3 to 10, and R is H or a methyl group.)

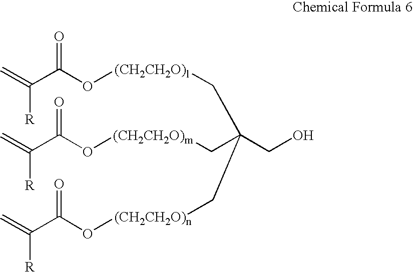

(In the chemical formula, the total of 1, m, and n is an integer of 3 to 10, and R is H or a methyl group.)

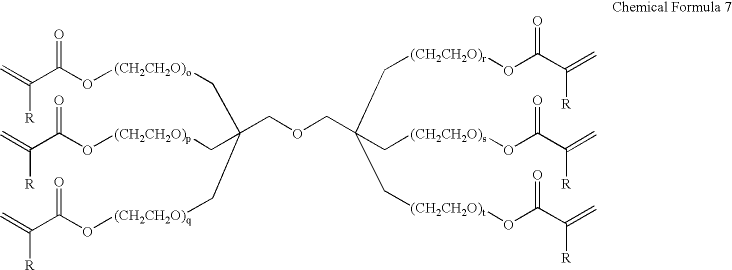

(In the chemical formula, the total of o, p, q, r, s and t is an integer of 3 to 10, and R is H or a methyl group.)

It is necessary that the hard coating layer in the first aspect of the present invention contain (meth)acrylate, which can be formed by curing the above ethylene oxide modified monomer. It is preferable that number of ethylene oxide groups in the ethylene oxide modified monomer be 2 to 10, and if the number of groups is 11 or more, hardness or mechanical characteristics may be decreased. In addition, it is preferable that three or more (meth)acrylate groups be included in the monomer as shown in the above Chemical Formulas 5 to 7, in order to obtain heat resistance, abrasion resistance, and solvent resistance in the hard coating layer. Furthermore, the compounds can be mixed with monomers, oligomers or prepolymers properly, in order to control characteristics of the hard coating layer.

In the case in which a cured film is required to have flexibility in the hard coating layer, the content of the monomers is preferably reduced, and in order to further decrease the crosslinking density, monomers of the monofunctional or the bifunctional acrylate type are preferably employed. In contrast, in the case in which the cured film is required to have extreme durability such as heat resistance, abrasion resistance, solvent resistance, etc., in the hard coating layer, it is preferable that the content of the monomers be increased and that monomers which are trifunctional or more of the acrylate type be employed.

In the present invention, as a common radiation curable resin, for controlling properties of coating material and coating film such as viscosity, cross-link density, heat-resistance, chemical resistance, etc., composite appropriately mixed monomers, oligomers, or prepolymers having a polymeric unsaturated bonding such as an acryloyl group, methacryloyl group, acryloyloxy group, methacryloyloxy group, etc., can be employed. As a monomer, styrene, methyl acrylate, methyl methacrylate, methoxy polyethylene methacrylate, cyclohexyl methacrylate, phenoxyethyl methacrylate, ethylene glycol dimethacrylate, dipentaerythritol hexiaacrylate, trimethylolpropane trimethacrylate, etc., can be employed.

As an oligomer and a prepolymer, acrylates such as polyester acrylate, polyurethane acrylate, epoxy acrylate, polyether acrylate, alkyd acrylate, melamine acrylate, silicon acrylate, etc.; unsaturated polyester; epoxy type compound; or the like, can be employed.

In order to cure the above radiation curable resin, for example, radiation such as ultraviolet light, electron beams, and X-rays may be emitted, and a polymerization initiator may be appropriately added as necessary. Any polymerization initiator in which active radicals or cations are generated by emissions such as heat, visible light, ultraviolet light, etc., can be employed without any limitation. As a polymerization initiator which generates active radicals by heat, azo compounds such as 2,2′-azobis(2,4-dimethyl valeronitrile), etc., organic peroxides such as benzoyl peroxide, lauroyl peroxide, etc., or the like can be employed. As a polymerization initiator which generates active radicals by emissions, acetophenones such as diethoxy acetophenone, 2-hydroxy-2-methyl-1-phenylpropan-1-one, benzyl dimethyl ketal, 1-hydroxy cyclohexyl-phenylketone, 2-methyl-2-morpholino (4-thiomethylphenyl) propan-1-one, etc., benzoin ethers such as benzoin methylether, benzoin ethylether, benzoin isopropylether, benzoin isobutylether, etc., benzophenones such as benzophenone, o-benzoyl methylbenzoate, 4-phenyl benzophenone, 4-benzoyl-4′-methyl-diphenylsulfide, 4-benzoyl-N,N-dimethyl-N-[2-(1-oxo-2-propenyloxy) ethyl] benzene methanaminium bromide, (4-benzoylbenzyl) trimethyl ammonium chloride, etc., thioxanthones such as 2,4-diethyl thioxanthone, 1-chloro-4-dichloro thioxanthone, etc., 2,4,6-trimethylbenzoyl diphenylbenzoyl oxide, or the like can be employed. In addition, as a cationic polymerization initiator which generates cations, triphenylsulfonium hexafluoroantimonate, tris(4-methoxyphenyl) sulfonium hexafluorophosphate, etc., can be employed.

These may be employed alone or in combination. In addition, as an accelerator (sensitizer), an amine-type compound such as N,N-dimethyl paratoluidine, 4,4′-diethylamino benzophenone, etc., can be employed in combination. The added amount of the initiator is preferably in the range of 0.1 to 10% by weight, and more preferable in the range of 3 to 7% by weight, relative to the radiation curable resin. In the case in which the initiator is in excess, some degradation products of the unreacted polymerization initiator result in reduction of the layer strength and discoloring of the resin. In contrast, in the case in which the amount is insufficient, the resin does not cure. In addition, in a Polymerization initiator which generates active radical by using emissions such as visible light, ultraviolet light, etc., a filler having an absorption in the wavelength region of irradiation emission may be used, and in this case, it is necessary that the ratio of the polymerization initiator be increased. Furthermore, a stabilizer (a thermal polymerization inhibitor) for the radiation curing resin such as hydroquinone, p-benzoquinone, t-butylhydroquinone, etc., may be added, and in this case, the added amount of the stabilizer is preferably in the range of 0.1 to 5.0% by weight to resin components.

The volumetric shrinkage ratio associated with curing of the hard coating layer employing the above radiation curable resin (calculated by the following method) is preferably 20% or less. With 20% or more of the volumetric shrinkage ratio, in the case of a film-shaped transparent substrate, the film will curl extremely, and in the case of a rigid substrate such as a glass or the like, the adhesion between the substrate and the hard coating layer is reduced.

### Expression 1

Volumetric shrinkage ratio: D=(S−S′)/S×100

wherein S: specific gravity before curing
S′: specific gravity after curing

### (Specific gravity is measured by the B method picnometer method of Japanese Industrial Standard JIS K-7112.)

In the hard coating layer according to the present invention, a stabilizer (a thermal polymerization inhibitor) for the radiation curable resin such as hydroquinone, p-benzoquinone, t-butylhydroquinone, etc., may be added. It is preferred that the stabilizer be employed in a range of 0.1 to 5.0% by weight to the radiation curable resin.

As a thermosetting resin which can be used in the hard coating layer, phenol resin, furan resin, xylene-formaldehyde resin, ketone-formaldehyde resin, urea resin, melamine resin, aniline resin, alkyd resin, unsaturated polyester resin, epoxy resin, etc., can be employed. These may be employed alone or in combination. In the case in which a transparent substrate consists of plastic, a heat curing temperature cannot be set at a high temperature. In particular, in the case in which PET or TAC is employed, a thermosetting resin that can be cured at 100° C. or less is desirably employed.

It is preferable that the curable resin employed in the hard coating layer have a higher transparency. The light permeability (Japanese Industrial Standard JIS K-7361-1) is preferably 80% or more, and more preferably 90% or more, similarly to the case of the transparent substrate. The refractive index of the hard coating layer is different between the case (1) in which the hard coating layer and the low refractive layer (fluorine-containing polymer film) are provided on the transparent substrate, and the case (2) in which the hard coating layer, the high refractive index layer, and the low refractive layer (fluorine-containing polymer film) are provided on the transparent substrate.

In the case (1), the refractive index of the hard coating layer is preferably in a range of 1.50 to 1.70, and more preferably in a range of 1.60 to 1.70. In the case (2), the refractive index of the hard coating layer is preferably in a range of 1.45 to 1.55. When it deviates from the above range, suitable anti-reflection properties cannot be obtained.

In order to increase the refractive index of the above hard coating layer, high refractive index fine particles such as metal microparticles (see the following description) may be contained. Furthermore, in order to increase the refractive index of the above resin, resins containing an aromatic ring or a halogen element such as Br, I, or Cl, may be selected. As a resin containing an aromatic ring, styrenes such as polystyrene, PET, polycarbonate of bisphenol A, etc., can be employed. As a resin containing a halogen element, polyvinylchloride, polytetrabromobisphenol A glycidylether, etc., can be employed. In addition, resins containing S, N, P, etc., also have a high refractive index, and specifically, polyvinylpyridine, polybisphenol S glycidylether, etc., can be employed.

In the present invention, as a method for forming a hard coating layer, directly or via another layer, on one surface or two surfaces of the transparent substrate, a method consisting of the steps of: mixing a filler, water, or an organic solvent in the resin described above, as necessary; dispersing the mixture using a paint shaker, sand mill, peal mill, ball mill, attritor, roll mill, high-speed impeller disperser, jet mill, high-speed impact mill, ultrasonic disperser, etc., to form a coating material or an ink; providing a mono-layer or multi-layers on one surface or two surfaces of the transparent substrate by means of a printing method such as a letterpress printing such as flexographic printing or the like, an intaglio printing such as direct gravure printing, offset gravure printing, or the like, a planographic printing such as offset printing or the like, a stencil printing such as screen process printing or the like, or a coating such as air doctor coating, blade coating, knife coating, reverse coating, transfer roll coating, gravure roll coating, kiss coating, cast coating, spray coating, slot orifice coating, calender coating, electrodeposition coating, dip coating, die coating or the like; thermal-drying the coating or printing layers in the case in which a solvent is included; and curing the coating or printing layers by means of heat or radiation (in the case of ultraviolet light, a photopolymerization initiator is necessary), can be employed. In the case in which the radiation is an electron beam, an electron beam having an energy of 50 to 1000 KeV emitted from various electron beam accelerators such as a Cockroft-Walton's apparatus, Van de Graaff apparatus, resonance transformer apparatus, insulating core transformer apparatus, linear type apparatus, dynamitron type apparatus, high-frequency type apparatus, or the like is employed. In the case in which the radiation is ultraviolet light radiation, the ultraviolet light radiation emitted from the light of an extra-high-pressure mercury vapor lamp, high pressure mercury vapor lamp, low pressure mercury vapor lamp, carbon arc lamp, xenon arc lamp, metal halide lamp, or the like can be employed.

In order to improve the coating ability or printing ability of a coating material and an ink, a leveling agent such as a silicone oil, etc., fats and oils such as polyethylene wax, carnauba wax, higher alcohol, bisamide, higher fatty acids, etc., a curing agent such as isocyanate, etc., an additive such as ultra-microparticles having a particle size of 0.1 μm or less, such as calcium carbonate, silica sol, synthetic mica, etc., can be employed, as necessary.

The thickness of the hard coating layer is preferably in a range of 1 to 10 μm, and is more preferably in a range of 1 to 5 μm. In the case in which the thickness of the hard coating layer is less than 1 μm, wear resistance of the hard coating layer is deteriorated, or in the case in which a ultraviolet ray curable resin is employed in the hard coating layer, the resin fails to cure due to oxidation inhibition. In contrast, in the case in which the thickness of the hard coating layer is more than 10 μm, curling occurs due to curing-shrinkage of the resin, microcracking occurs in the hard coating layer, or the adhesion between the transparent substrate and the hard coating layer is decreased.

C. High Refractive Index Layer

In order to further improve the anti-reflection effect, a high refractive index layer can be provided between the hard coating layer and the fluorine-containing polymer film. Here, the refractive index of the high refractive index layer is higher than those of the hard coating layer and the fluorine-containing polymer film.

The high refractive index layer must have a higher refractive index than the fluorine-containing polymer film formed over the layer, and the refractive index is preferably 1.60 to 1.90. In the case in which the refractive index is less than 1.60, it is difficult to obtain sufficient low-reflection effects, and in contrast, in the case in which it is more than 1.90, it is difficult to form a film.

The thickness of the high refractive index layer is preferably equal to or less than the wavelength of visible light. For example, in the case in which the anti-reflection effect is provided in visible light, the thickness of the high refractive index layer is designed so that nd satisfies the expression 500≦4nd (nm)≦750. Here, n is the refractive index of the high refractive index layer, and d is thickness of the layer. In the second aspect of the present invention, since the high refractive index layer is thin as described above, sufficient hard coating properties cannot be obtained. Therefore, it is necessary to provide the hard coating layer between the high refractive index layer and the transparent substance.

As a material used in the high refractive index layer, as described also for the above hard coating layer, organic high refractive index material containing aromatic rings, or halogen such as Br, I, Cl, etc., material containing high refractive index fine particles such as metal microparticles, or the like, can be employed. As such high refractive index fine particles, TiO₂ (refractive index: n=2.3 to 2.7), CeO₂ (n=1.95), ZnO (n=1.9), Sb₂O₅ (n=1.71), SnO₂ (n=1.95), ITO (n=1.95), Y₂O₃ (n=1.87), La₂O₃ (n=1.95), ZrO₂ (n=2.05), Al₂O₃ (n=1.63), HfO₂ (n=2.0), Ta₂O₅, etc., can be employed. In the case in which conductive fine particles such as ITO are used, surface resistance can be decreased, and thereby, anti-static properties can be further obtained.

In the present invention, in order to control properties of coating materials and coating films, such as viscosity, cross-linking density, heat-resistance, chemical resistance, curability, etc., monomers, oligomers, or prepolymers having polymeric unsaturated bonding such as acryloyl group, methacryloyl group, acryloyloxy group, methacryloyloxy group, etc., may be appropriately mixed as a binder with the organic high refractive index material containing aromatic ring, or halogen such as Br, I, Cl, etc., and the material containing high refractive index fine particles such as metal microparticles; however, it is necessary to use at least the above ethylene oxide modified (meth)acrylate as a binder.

The high refractive index layer is formed by irradiating radiation such as ultraviolet light, an electron beam, X-rays, etc., onto the above high refractive index material, and the polymerization initiator can be added as necessary. As a polymerization initiator, the same compounds as those explained in the above description with respect to the hard coating layer can be employed.

As a method for forming the high refractive index layer, methods such as a dry coating method, a wet coating method, or the like can be employed without any limitation. In particular, the high refractive index layer in the present invention is formed by the wet coating method, and the same methods as those explained in the above description with respect to the hard coating layer can be employed.

The high refractive index layer is produced by irradiating ultraviolet light, an electron beam, etc., as necessary or by heating, after forming by the wet coating method. Of these, it is preferable that the curing reaction by ultraviolet light be carried out under an atmosphere of inert gas such as nitrogen, argon, etc., since oxidation inhibition of curing is prevented.

### D. Fluorine-Containing Polymer Film

In the present invention, in order to obtain anti-reflection properties, a low refractive index layer adjusted refractive index is provided on the outmost surface of the low-reflection material. As a low refractive index layer, a fluorine-containing polymer film made of fluorine organic compounds can be employed. As a fluorine organic compound for forming the fluorine-containing polymer film, fluorine-containing monomers, fluorine-containing oligomers, fluorine-containing prepolymers, and fluorine-containing polymers having polymeric unsaturated bonding such as acryloyl group, methacryloyl group, acryloyloxy group, methacryloyloxy group, etc., can be employed alone or in combination properly.

As a monofunctional fluorine-containing monomer, acrylates, methacrylates, fluoroacrylates, (meth)acrylates having an epoxy group, hydroxyl group, carboxyl group, etc., or the like can be employed, and for example, compounds shown by structural formula CH₂=CX—COORf (in the formula, X is H, CH₃ or F, and Rf is fluorine-containing alkyl group having a carbon number of 2 to 40 or a fluorine-containing alkyl ether group having a carbon number of 2 to 100) are preferable.

As such compounds, fluorine-containing methacrylates such as 2-(perfluorodecyl)ethyl methacrylate, 2-(perfluoro-7-methyloctyl)ethyl methacrylate, 3-(perfluoro-7-methyloctyl)-2-hydroxypropyl metbacrylate, 2-(perfluoro -9-methyldecyl)ethyl methacrylate, 3-(perfluoro-8-methyldecyl)-2-hydroxypropyl methacrylate, etc., fluorine-containing acrylates such as 3-perfluorooctyl-2-hydroxypropyl acrylate, 2-(perfluorodecyl)ethyl acrylate, 2-(perfluoro-9-methyldecyl)ethyl acrylate, etc., or the like, can be employed.

As a multifunctional fluorine-containing monomer, compounds in which an acrylate group, methacrylate group, or flubroacrylate group is substituted for a hydroxyl group in a polyalcohol such as a diol, triol, tetraol, etc., can be employed.

Specifically, compounds in which an acrylate group, methacrylate group, or fluoroacrylate group is substituted for two hydroxyl groups or more in a polyalcohol such as 1,3-butanediol, 1,4-butanediol, 1,6-hexanediol, diethylene glycol, tripropylene glycol, neopentyl glycol, trimethylol propane, pentaerythritol, di-pentaerythritol, etc., can be employed.

In addition, polyfunctional acrylic monomers in which an acrylate group, methacrylate group, or fluoroacrylate group is substituted for two hydroxyl groups or more in polyalcohol having fluorine-containing alkyl group, fluorine-containing alkyl group having an ether bond, fluorine-containing alkylene group, or fluorine-containing alkylene group having an ether bond, can also be employed, and in particular, the compounds are preferable since the refractive index of the cured material can be maintained at a low level. As an example of such compounds, compounds in which an acrylate group, methacrylate group, or fluoroacrylate group is substituted for two hydroxyl groups or more in a fluorine-containing polyalcohol shown in Chemical Formulas 8 to 13, can be preferably used.

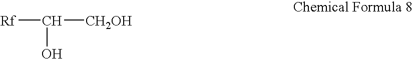

(In the chemical formula, Rf is a fluorine-containing alkyl group having a carbon number of 1 to 40.)

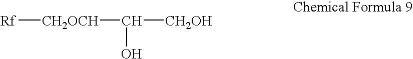

(In the chemical formula, Rf is a fluorine-containing alkyl group having a carbon number of 1 to 40.)

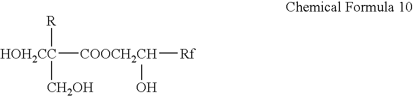

(In the chemical formula, Rf is a fluorine-containing alkyl group having a carbon number of 1 to 40 or a fluorine-containing alkyl group having an ether bond, and R is H or an alkyl group having a carbon number 1 to 3.)

Chemical Formula 11

HO—CH₂—Rf—CH₂OH

(In the chemical formula, Rf is a fluorine-containing alkylene group having a carbon number of 1 to 40 or a fluorine-containing alkylene group having an ether bond, and R is H or an alkyl group having a carbon number of 1 to 3.)

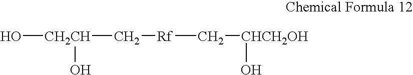

(In the chemical formula, Rf′ is a fluorine-containing alkylene group having a carbon number of 1 to 40 or a fluorine-containing alkylene group having an ether bond, and R is H or an alkyl group having a carbon number of 1 to 3.)

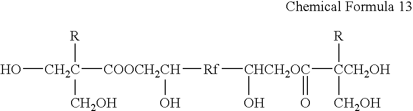

(In the chemical formula, Rf′ is fluorine-containing alkylene group having acarbon number of 1 to 40 or a fluorine-containing alkylene group having an ether bond, and R is H or an alkyl group having a carbon number of 1 to 3.)

Furthermore, in the present invention, as a fluorine-containing prepolymer or a fluorine-containing polymer, polyvinyl fluoride (PVF), polyvinylidene fluoride (PVDF), polytrifluoroethylene (PTrFE), polytetrafluoroethylene (PTFE), etc., can be employed. In addition, in the present invention, it is preferable that the fluorine-containing polymer have a carbon-carbon unsaturated bond in a side-chain, since a polymer film having low refractive index and high hardness can be formed. Specifically, polymers having a structure shown in Chemical Formula 14 can be used.

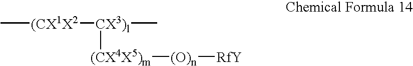

(In the chemical formula, X¹ and X² are the same or different, and are H or F. X³ is H, F, CH₃, or CF₃, X⁴ and X⁵ are the same or different, and are H, F or CF₃. Rf is a fluorine-containing alkylene group having a carbon number of 1 to 40 or a fluorine-containing alkylene ether group having a carbon number of 2 to 100, Y is a monovalent organic group having a carbon number of 2 to 10 having an ethylene type carbon-carbon double bond, m is integer of 0 to 3, and n is 0 or 1.)

As a functional group Y in the above Chemical Formula 14, —CH=CH₂, —CF=CH₂, —C(CH₃)=CH₂, —CF=CF₂, —CH=CHF, —O—CO—CH=CH₂, —O—CO—C(CH₃)=CH₂, —O—CO—CF=CH₂, —O—CO—C(CF₃)=CH₂, —O—CO—CF=CF₂, etc., can be employed. Of these, when the functional group is —O—CO—CF=CH₂, the refractive index can be decreased and curing (cross-linking) reaction can be efficiently carried out.

As a functional group Rf in the above Chemical Formula 14, —(CF₂)ₘ—(CH₂)ₙ—, —(CF₂C(CF₃)F)ₘ—(CH₂)ₙ—, —(CH₂CF₂)ₘ—(CH₂)ₙ—, —(CH₂)ₙ—C(CF₃)₂—, (in the above functional groups, m is an integer of 1 to 10, and n is an integer of 0 to 5), —(CF₂CF₂)₁—(CF₂C(CF₃)F)ₘ—(CH₂)ₙ—, —(CH₂CF₂)₁—(CF₂CF₂)ₘ—(CH₂)ₙ—, —(CF₂)ₙ—C(CF₃)₂—, —(CH₂CF₂)₁—(CF₂C(CF₃)F)ₘ—(CH₂)ₙ—, (in the above functional groups, 1 is an integer of 1 to 10, m is an integer of 1 to 10, and n is an integer of 0 to 5), —CF₂CF₂O)ₙ—, —(CF₂CF₂CF₂O)ₙ—, —(C(CF₃)FCF₂O)ₙ—, —(C(CF₃)FCF₂O)ₙ—C(CF₃)F—, —(C(CF₃)FCF₂O)ₙ—C(CF₃)FCH₂—, —(CF₂CF₂O)ₙ—CF₂—, —(CF₂CF₂O)ₙ—CF₂CH₂—, —(CF₂CF₂CF₂O)ₙ—CF₂CF₂—, —(CF₂CF₂CF₂O)ₙ—CF₂CF₂CH₂—, (in the above functional groups, n is an integer of 1 to 30), etc., can be used.

In the case in which the carbon number of the fluorine-containing alkyl group is too large, solubility in a solvent is decreased or transparency is reduced. In addition, in the case in which the carbon number of the fluorine-containing alkyl ether is too large, the hardness or mechanical characteristics of the cured material is reduced.

It is preferable that the above light curable polymer having carbon-carbon double bond in side chain be copolymerized with a fluorine-containing polymer as shown in Chemical Formula 15.

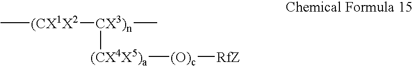

the chemical formula, X¹ X² are the same or different, and are H or F. X³is H, F, CH₃, or CF₃, X⁴ and X⁵ are the same or different, and are H, F or CF₃. α is an integer of 0 to 2, and c is 0 or 1. Rf is a fluorine-containing alkylene group having a carbon number of 1 to 40 or a fluorine-containing alkylene ether group having a carbon number of 2 to 100, and Z is selected from —OH, —CH₂OH, —COOH, carboxylic acid derivative, —SO₃H, sulfonic acid derivative, epoxy group, and cyano group.)

Adhesion to the substrate and solubility in a common solvent can be obtained, while a low refractive index is maintained, by copolymerizing the above polymer.

In the present invention, a fluorine-containing monofunctional monomer, a fluorine-containing multifunctional monomer, and a fluorine-containing polymer can be used alone or in appropriate combination. The fluorine-containing polymer film is formed by irradiating radiation such as ultraviolet light, an electron beam, X-ray, etc., onto the above fluorine organic compound, and a polymerization initiator can be added to the fluorine organic compound as necessary. As a polymerization initiator, the same compounds as those explained in the above description with respect to the hard coating layer can be employed.

The refractive index of the fluorine-containing polymer film is preferably 1.20 to 1.45, in order to obtain an anti-reflection effect. In the case in which the refractive index is more than 1.45, it is difficult to obtain a sufficient low-reflection effect, and in contrast, in the case in which it is less than 1.20, it is difficult to form a film.

The thickness of the fluorine-containing polymer film is preferably equal to or less than the wavelength of visible light. For example, in the case in which anti-reflection an effect is provided in visible light, the thickness of the fluorine-containing polymer film is designed so that nd satisfies 500≦4nd (nm)≦750. Here, n is the refractive index of the fluorine-containing polymer film, and d is the thickness of the layer.

The fluorine-containing polymer film in the present invention is formed by the wet coating method and the same methods as those explained in the above description with respect to the hard coating layer can be employed.

The fluorine-containing polymer film is produced by irradiating ultraviolet light, an electron beam, etc., as necessary or by heating, after forming by the wet coating method. Of these, it is preferable that a curing reaction by ultraviolet light be carried out under an atmosphere of inert gas such as nitrogen, argon, etc., since oxidation inhibition in the curing is prevented.

### EXAMPLES

In the following, the present invention will be explained by Examples. Hereinbelow, “part” means “part by weight”.

### Example 1

Production of Hard Coating Layer

The following hard coating coating material was applied to a PET film (trade name: A 4300, produced by Toyobo Co., Ltd.) having a thickness of 100 μm by using a reverse coating method, and after drying at 100° C. for 1 minute, the coating was cured in a nitrogen gas atmosphere by irradiation with ultraviolet light (irradiation distance: 10 cm, irradiation time: 30 seconds) using a converging type high pressure mercury lamp of 120 W/cm. As a result, a hard coating layer having a thickness of 2.5 μm was produced.

### Mixing Ratio of Hard Coating Coating Material

49 parts of EO modified trimethylolpropane triacrylate (trade name: TMP-6EO-3A, produced by Kyoeisha Chemical Co., Ltd.),

1 parts of photoinitiator (trade name: IRGACURE 184, produced by Ciba-Geigy Co., Ltd.), and

50 parts of methylethylketone.

The above EO modified trimethylolpropane triacrylate is shown in the following Chemical Formula 16.

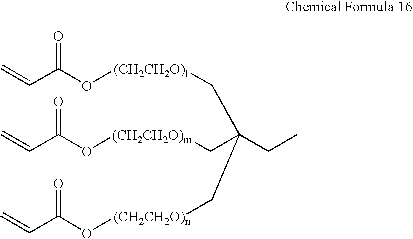

(In the chemical formula, the total of 1, m, and n is 6.)

Production of Low Refractive Index Layer

The following low refractive index coating material was applied to the above hard coating layer by using a reverse coating method, and after drying at 100° C. for 1 minute, the coating was cured by irradiation in a nitrogen gas atmosphere with ultraviolet light (irradiation distance: 10 cm, irradiation time: 30 seconds) using a converging type high pressure mercury lamp of 120 W/cm. As a result, a high refractive index layer having a thickness of 0.1 μm was produced, and thereby, a low-reflection material of the present invention having a reflectivity of 1.45% was produced.

### Mixing Ratio of Low Refractive Index Coating Material

100 parts of fluorine-containing ultraviolet light curable resin having a carbon-carbon double bond in a side chain (trade name: AR100, total solid concentration: 15%, solvent: MIBK, produced by Daikin Industries, Ltd.),

1 parts of photoinitiator (trade name: IRGACURE 907, produced by Ciba-Geigy Co., Ltd.), and

43 parts of methylisobutylketone.

The above fluorine-containing ultraviolet ray curable resin is a COPolymer which includes a fluorine-containing polymer having a carbon-carbon double bond in a side chain.

### Comparative Example 1

A comparative low-reflection material having a reflectivity of 1.46% was produced in the same manner as that in Example 1, except that the mixing ratio was changed to the following ratio.

### Mixing Ratio of Hard Coating Coating Material

49 parts of trimethylolpropane triacrylate (trade name: TMP-A, produced by Kyoeisha Chemical Co., Ltd.),

1 part of photoinitiator (trade name: IRGACURE 184, produced by Ciba-Geigy Co., Ltd.), and

50 parts of methylethylketone.

The above trimethylolpropane triacrylate is shown in the following Chemical Formula 17.

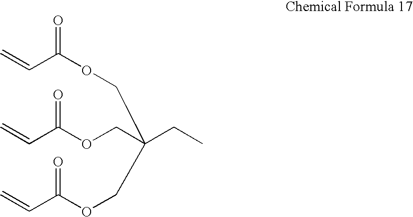

(In the chemical formula, the total of 1, m, and n is 6.)

With regard to the low-reflection material of Example 1 and the comparative low-reflection material of Comparative Example 1 as obtained above, total light transmittance, reflectance, and wear resistance were measured and evaluated by the following methods.

The total light transmittance was measured using a HAZE meter (trade name: NDH 2000, produced by Japan Electric Color Co., Ltd.).

5 degree specular reflection was measured at wavelengths of 400 to 700 nm using a spectrophotometer (trade name: UV 3100, produced by Shimadzu Corporation) and was luminosity-corrected in accordance with Japanese Industrial Standard JIS Z-8701, and the reflectivity is shown by a Y value. Here, after the non-measured surface of the film was completely painted with black magic ink, the measurements were carried out.

Steel-wool #0000 produced by Nippon Steel Wool Co., Ltd., was mounted on a paperboard abrasion resistance test machine (produced by Kumagai Riki Kogyo Co., Ltd.), and was rubbed on the surface of the low refractive index layer of the low-reflection material 10 times with a 250 g load. Then, the change in the HAZE value, AHAZE (according to the expression in the following) on the rubbed portion was measured by a HAZE meter. Here, the larger the measured value, the worse the abrasion resistance. Change of HAZE value: ΔHAZE=HAZE value after testing −HAZE value before testing

TABLE 1

| | | | | | | Abrasion |
|---|---|---|---|---|---|---|
| | | Number of | | Total Light | | Resistance |
| | Hard Coating | Acryloyl | Number of EO | Transmittance | Reflection | ΔHAZE |
| | Material | Groups | Modifications | (%) | (%) | (%) |
| Example 1 | TMP-6E0-3A | 3 | 6 | 93.88 | 1.45 | 0.80 |
| Comparative | TMP-A | 3 | 0 | 93.82 | 1.46 | 1.85 |
| Example 1 | | | | | | |

As is apparent from Table 1, in the low-reflection material of Example 1 according to the present invention, superior abrasion resistance was exhibited by using ethylene oxide modified methacrylate in the hard coating layer, and in contrast, in the low-reflection material of Comparative Example 1, there was a problem in abrasion resistance, and the comparative low-reflection material could not be used in practice.

As explained above, a low-reflection material according to the present invention which comprises a hard coating layer including ethylene oxide modified (meth)acrylate resin provided on a transparent substrate and a fluorine-containing polymer film provided on the hard coating layer, exhibit superior abrasion resistance.

1. A low-reflection material comprising a transparent substrate, a hard coating layer provided on the transparent substrate, and a fluorine-containing polymer film provided on the hard coating layer,
wherein the hard coating layer contains ethylene oxide modified (meth)acrylate resin, and
the ethylene oxide modified (meth)acrylate resin has three (meth)acryloyl groups or more in a monomer molecule.

2. A low-reflection material comprising a transparent substrate, a hard coating layer provided on the transparent substrate, a high refractive index layer provided on the hard coating layer, and a fluorine-containing polymer film provided on the high refractive index layer,
wherein the high refractive index layer contains ethylene oxide modified (meth)acrylate resin, and
the ethylene oxide modified (meth)acrylate resin has three (meth)acryloyl groups or more in a monomer molecule.

3. The low-reflection material according to claim 1, wherein the fluorine-containing polymer film contains at least cured material of a radiation curable fluorine-containing polymer having a carbon-carbon double bond in a side chain.

4. The low-reflection material according to claim 2, wherein the fluorine-containing polymer film contains at least cured material of a radiation curable fluorine-containing polymer having a carbon-carbon double bond in a side chain.
